(19) United States
(12) Patent Application Publication
(10) Pub. No.: US 2004/0152830 A1
(43) Pub. Date: Aug. 5, 2004

(54) Hydrolytically stable polymer dispersion

(76) Inventors: Kyu-Jun Kim, Chapel Hill, NC (US); Steve Mochrie, Cary, NC (US); Shi Yang, Cary, NC (US)

Correspondence Address: MYERS BIGEL SIBLEY & SAJOVEC, PO BOX 37428, RALEIGH, NC, 27627, US

(21) Appl. No.: 10/743,594

(22) Filed: Dec. 22, 2003

Related U.S. Application Data
(63) Continuation-in-part of application No. 10/328,124, filed on Dec. 23, 2002.
(60) Provisional application No. 60/471,006, filed on May 16, 2003.

(51) Int. Cl. C08L 67/00

(52) U.S. Cl. 524/599

(57) ABSTRACT

Hydrolytically stable polymer dispersions include ester linkages protected by hydrophobic alkyl groups which may be formed from polyester and alkyd polymer having ester linkages formed from secondary and/or tertiary hydroxy groups.

### CROSS-REFERENCE TO RELATED APPLICATIONS

This application is a continuation-in-part of, and claims the benefit of and priority to the following United States Applications, which are incorporated herein by reference in their entireties: pending U.S. patent application Ser. No. 10/328,124 filed on Dec. 23, 2002 and U.S. Provisional Patent Application Serial No. 60/471,006 filed on May 16, 2003.

### FIELD OF THE INVENTION

This invention relates to polymer dispersions and more particularly to hydrolytically stable polymer dispersions that may be used in the ink, coatings, and adhesive industries.

### BACKGROUND OF THE INVENTION

Environmental concerns over the use of volatile organic compounds have sparked tighter regulations regarding their use in many industries. For instance, polyesters and alkyds have been widely used with volatile organic compounds in the ink, coatings, and adhesive industries. However, recent environmental regulations mandate the use of lower amounts of volatile organic compounds in those industries. As a result, alternative compositions and methods have been developed to produce inks, coatings, and adhesives having lower amounts of volatile organic compounds.

In an effort to reduce the use of volatile organic compounds in the ink, coatings, and adhesive industries, the viscosity of the polymers being produced are lowered. This may be accomplished by reducing the molecular weight of the polymers used in the ink, coatings, and adhesive compositions, or in other words, by adopting a “high solids” approach wherein the resins include high levels of polymer solids having lower molecular weights. The “high solids” polymers are also being used in an attempt to reduce the amount of volatile organic compounds. The use of the “high solids” approach, however, is not without problems in performance and application due to the inherent low molecular weight of such formulations.

As an alternative to solvent based “high solids” approach, industry has been exploring water-based coating polymers. However, many of the water-dispersible polymer and alkyd dispersions face difficulties because the polyester and alkyd are prone to degradation due to the hydrolysis of ester linkages in the polymers of the dispersions. The shelf life of the water dispersible polymer dispersions used in the ink, coatings, and adhesive industries is dependent, mostly, upon the integrity of ester linkages within the polymer dispersions. The ester linkages in the polymer dispersions are prone to hydrolysis. The hydrolysis of the ester linkages in a polymer dispersion during the storage period lowers the molecular weight of the polymer dispersion and hinders the performance of the ink, coating, or adhesive containing the polymer dispersion. Therefore, methods for improving the hydrolytic stability of polymer dispersions and hydrolytically stable polymer dispersions are desirable.

In an attempt to develop stable water borne polymer compositions, dispersion-stable polymeric acid functional polyols that are the reaction product of polyols having terminal secondary or tertiary hydroxyl groups have been developed. For example, United State Patent Application Publication 2002/0183443 describes such compositions and methods of making such compositions. However, the presence of only a terminal hydrolytically stable ester linkage based on secondary or tertiary hydroxyl group may only partially improve the hydrolytic stability of a polymer dispersion since most ester linkages are located in the backbone of polymer chain and they are easily exposed to water and subject to hydrolysis.

Others methods and compositions have also been developed in an attempt to improve the stability and shelf life of water-reducible alkyd compositions. For instance, core/shell alkyds have been developed wherein acrylic monomers are grafted to fatty acids and the formed acrylic grafted fatty acids are reacted with hydroxyl terminated alkyds prepared with excess of primary hydroxy functional groups. The acrylic polymer acts as a shell for the alkyd core. The hydrolysis-prone core alkyd developed in this manner is partially protected from water, and hydrolysis, by the shell acrylic polymer.

The use of core/shell alkyd compositions provide some protection from hydrolysis for the primary ester linkages of the core alkyds over water-reducible alkyds. However, the primary ester linkages of the core/shell alkyds are not immune to hydrolysis and such compositions tend to break down over time due to hydrolysis of the primary ester linkages.

Therefore, it would be beneficial to develop a water dispersible polymer composition that may slow the effects of hydrolysis and provide compositions having a longer shelf life, greater hydrolytic stability and a longer useable life.

### SUMMARY OF THE INVENTION

According to embodiments of the present invention, hydrolytically stable polymer dispersions may be formed from polyesters and alkyd polymers wherein at least a portion of the ester linkages in the polymer dispersion are formed from secondary or tertiary hydroxy groups. The formation of ester linkages from secondary or tertiary hydroxy groups in the dispersions provides hydrophobic characteristics to the dispersion, which hinder the hydrolysis of the ester linkages by water. The presence of hydrolytically stable ester linkages throughout the polymer chain improves the hydrolytic stability of polymer. The hindered hydrolysis allows the dispersions to have a longer shelf life and better application characteristics.

In some embodiments of the present invention, at least 5 mole percent or more, or preferably at least 25 mole percent or more, of the ester linkages in the hydrolytically stable polymer dispersion are formed from secondary and/or tertiary hydroxy groups.

According to embodiments of the present invention, the hydrolytically stable polymer dispersions of the present invention may be produced by forming an ionic salt from the polymers in the dispersion. In other embodiments, the hydrolytically stable polymer dispersion may be produced by mixing a hydrolytically stable polymer with an emulsifier and water and subjecting the mixture to shear forces. In still other embodiments, the hydrolytically stable polymer dispersion may also be produced by incorporating hydrophilic moieties into hydrolytically stable polymers.

### BRIEF DESCRIPTION OF THE DRAWING FIGURES

The invention can be more readily ascertained from the following description of the invention when read in conjunction with the accompanying drawings in which:

FIG. 1 illustrates representative example of a polymer having an ester linkage formed from a primary hydroxy compound;

FIG. 2 illustrates representative example of a polymer having an ester linkage formed from a secondary hydroxy compound; and

FIG. 3 illustrates a graph showing the amount of hydrolysis of ester linkages in three hydrolytically stable polymer dispersions according to the present invention and a conventional dispersion.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

According to embodiments of the present invention, hydrolytically stable polymer dispersions may be formed from polyesters and alkyd polymers wherein at least a portion of the ester linkages in the polymer backbone are formed from secondary or tertiary hydroxy groups. The hydrolytically stable polymer may be dispersed in water by any number of methods, including, but not limited to, forming an ionic salt, emulsifying by shear force in the presence of emulsifiers, or by chemically incorporating hydrophilic moieties into the polymer.

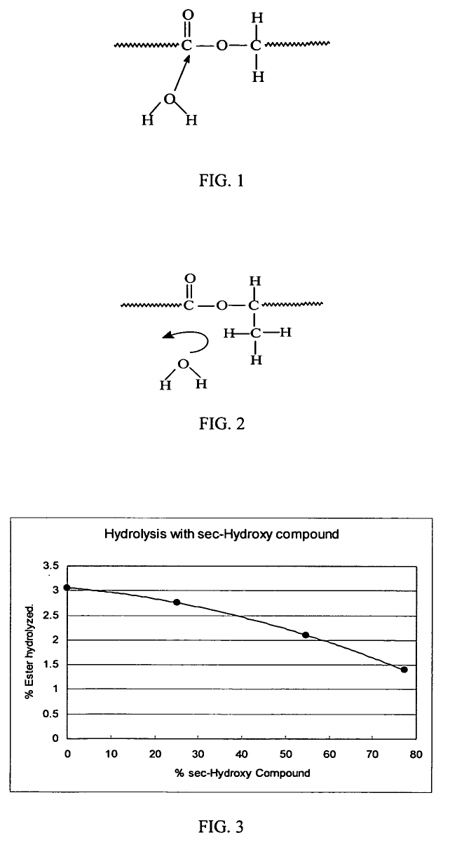

The hydrolysis of polyester and alkyd polymers occurs as a result of the hydrolysis of the ester linkages in the polymer. For example, a representative example of a polymer having an ester linkage with a primary hydroxy compound is illustrated in FIG. 1. As shown, the water molecule may easily access the ester linkage, resulting in the hydrolysis of the compound. One way to prevent the hydrolysis of the compound is to hinder access to the ester linkage by the water molecule. Hindered access to an ester linkage in a polyester and alkyd polymer dispersion may be achieved by the formation of a hydrophobic alkyl group next to the ester linkage as illustrated in FIG. 2. The presence of the hydrophobic alkyl group next to the ester linkage hinders or reduces access to the ester linkage by a water molecule. The hindered access results in a reduction of hydrolysis and a more hydrolytically stable polyester and alkyd polymer dispersion.

According to embodiments of the present invention, hydrophobic alkyl groups may be formed next to ester linkages by producing a polyester and alkyd polymer dispersion using secondary or tertiary hydroxy compounds. A portion of the resulting ester linkages resulting from the formation of polyester and alkyd dispersions using secondary or tertiary hydroxy groups are protected by the bulky, hydrophobic alkyl groups as illustrated in FIG. 2.

For example, a number of polyester dispersions were prepared with secondary hydroxy compounds according to embodiments of the present invention and compared to a polyester dispersion formed from primary hydroxy compounds to determine the amount of hydrolysis that occurred. The results are graphically illustrated in FIG. 3. Three of the four samples were prepared using varying amounts of secondary hydroxy compounds. All of the samples were heat aged at 48.9° C. for three weeks to simulate storage conditions. As illustrated in FIG. 3, the polyester dispersions formed using secondary hydroxy compounds exhibited reduced ester linkage hydrolysis as compared to the polyester dispersion that was formed from primary hydroxy compounds. Thus, the use of secondary hydroxy compounds during the formation of polyester and alkyd polymer dispersions reduces the hydrolysis of the dispersion.

According to embodiments of the present invention, a hydrolytically stable polymer dispersion may be formed by creating a polyester and alkyd dispersion wherein at least a portion of the ester linkages in the polymer backbones of the dispersion are formed from secondary and/or tertiary hydroxyl compounds. For instance, 5 mole percent, 10 mole percent, 15 mole percent, 20 mole percent, or 25 mole percent or more of the ester linkages in the dispersions may be formed from secondary and/or tertiary hydroxyl compounds. In some embodiments, at least 25 mole percent or more of the ester linkages in the dispersion are preferably formed from secondary and/or tertiary hydroxy groups. The hydrolytically stable polymer dispersions of the present invention may also include additional additives and/or reactants, including, but not limited to, primary hydroxy-containing polyols, polyacids, mono-hydroxy compounds, monoacids, fatty acids and oils.

The hydrolytically stable polymer dispersions of some embodiments of the present invention may be formed in a similar manner to the formation of conventional alkyd and polyester dispersions with one exception, the inclusion of secondary and/or tertiary hydroxy containing polyhydroxy compounds in the reaction. For example, secondary hydroxy containing polyol compounds may be added to a polymer dispersion formation reaction to ensure that at least 5 mole percent or more, or preferably 25 mole percent or more, of the ester linkages in the dispersion are formed from the secondary hydroxy groups. Secondary hydroxy group containing polyol compounds that may be used to form the hydrolytically stable polymer dispersions of the present invention include, but are not limited to, 2,2,4-trimethyl pentanediol, 2,2′-bis (4-hydroxycyclohexy) propane (also known as hydrogenated bisphenol A), propylene glycol, di-propylene glycol, poly (propylene glycol), glycerol, and sorbitol.

In other embodiments, an alkyl substituted epoxy and a cyclic carbonate may be included in the formation of the hydrolytically stable polymer dispersion in place of at least a portion of the secondary hydroxy containing compounds. A condensation reaction of an alkyl substituted epoxy or a cyclic carbonate with either the carboxy group or hydroxyl group results in the formation of a secondary hydroxy group during the condensation process. Examples of alkyl substituted epoxy and cyclic carbonate that may be used with embodiments of the present invention include glycidyl neodecanoate, diglycidyl ether of bisphenol A, diglycidyl ether of bisphenol F, pentaerythritol poly glycidyl ether, sorbitol polyglycydyl ether, propylene oxide, and propylene carbonate.

Primary hydroxy-containing polyols that may be used in the formation of hydrolytically stable polymer dispersions according to embodiments of the present invention include, but are not limited to, trimethylol propane, pentaerythritol, di-pentaerythritol, trimethylol ethane, neopentyl glycol, ethylene glycol, 1,3-butanediol, 1,4-butanediol, 1,6-hexanediol, 1,4-cyclohexyl dimethanol, diethylene glycol, triethylene glycol, poly (ethylene glycol), poly (tetrahydrofuran), poly(caprolactone) diol, poly(caprolactone) triol, trimethylol mono allylether, trimethylol diallyl ether, pentaerythritol triallylether, pentaerythritol diallyl ether, pentaerythritol mono allylether, 2-ethyl-2-(hydroxymethyl)-1,3-propanediol, and 2-methyl 1,3-propanediol.

The hydrolytically stable polymer dispersions of embodiments of the present invention may also be formed by polyacids, such as isophthalic acid, terephthalic acid, 5-(sodiosulfo)-isophthalic acid, trimellitic anhydride, adipic acid, 1,4-cyclohexyl dicarboxylic acid, succinic anhydride, maleic acid, fumaric acid, succinic acid, azaleic acid, sebacic acid, methyl succinic anhydride, dodecenyl succinic anhydride, tetrahydrophthalic anhydride, hexahydrophthalic anhydride, and phthalic anhydride.

Other compounds such as mono-functional alcohols and monoacids may also be used as reactants during the formation of hydrolytically stable polymer dispersions according to embodiments of the present invention. For instance, mono-functional alcohols such as alkoxy terminated poly(ethylene glycol) and alkoxy terminated poly(propylene) glycol may be included in the reaction. Monoacids such as benzoic acid and aliphatic hydrocarbon acids may also be included.

Hydrolytically stable polymer dispersions of the present invention may also include fatty acids and/or oils depending upon the type of application intended. For example, fatty acids may be included in dispersions that are cured under ambient conditions without the use of additional crosslinkers. In such applications, at least a portion of the fatty acids used in the dispersion is unsaturated. Examples of fatty acids that may be used with embodiments of the present invention include, but are not limited to, sunflower fatty acid, toll oil fatty acid, linseed oil fatty acid, safflower oil fatty acid, dehydrated castor oil fatty acid and soybean oil fatty acid.

In some instances, oils may be used in conjunction with or in place of the fatty acids. When oils are used with embodiments of the present invention, the hydroxy and carboxy equivalence ratio in the dispersion may need to be adjusted. Examples of oils that may be used with embodiments of the present invention include, but are not limited to, sunflower oil, toll oil, soybean oil, safflower oil, linseed oil, castor oil, dehydrated castor oil and tung oil.

Organic solvents may also be included in the hydrolytically stable polymer dispersions of the present invention. For example, organic solvents may be used to reduce the viscosity of a hydrolytically stable polymer dispersion of the present invention. Various organic solvents may be used, including, but not limited to, butoxy ethanol, butoxy propanol, propoxy propanol, methoxy propanol, dipropylene glycol methylether, tripropylene glycol methyl ether, dipropylene glycol n-butyl ether, and t-butoxy propanol.

The hydrolytically stable polymer dispersions of various embodiments of the present invention may be prepared by any number of methods including, but not limited to, forming an ionic salt from the dispersion, emulsifying the dispersion by shear force in the presence of emulsifiers, or by chemically incorporating hydrophilic moieties into the polymer.

According to embodiments of the present invention, a hydrolytically stable polymer may be dispersed into water by forming an ionic salt. An ionic salt may be formed from amine and carboxylic groups that are chemically bound to the polymers in the dispersion. Carboxylic groups may exist on the polymers in the dispersion from unreacted polyacids used in the formation of the hydrolytically stable polymer dispersion. In other instances, the carboxylic groups may be produced by reacting anhydrides to the hydrolytically stable polymer. Anhydride compounds may react with the hydroxy groups of the polymers to form carboxylic groups. Amines may then be added to the hydrolytically stable polymer dispersion to neutralize the dispersion and form the ionic salt.

Numerous anhydrides may be reacted to hydrolytically stable polymer dispersions of the present invention in the formation of ionic salts. For example, anhydrides used with the present invention may include, but are not limited to, trimellitic anhydride, maleic anhydride, phthalic anhydride, dodecenyl succinic anhydride, and succinic anhydride.

Amines that may be added to the hydrolytically stable polymer dispersions to neutralize the dispersions and form ionic salts include, but are not limited to, aqueous ammonia, triethyl amine, N,N-dimethyl ethanol amine, and N-methyl morpholine.

In other embodiments of the present invention, hydrolytically stable polymer of the present invention may be dispersed in water after forming a urethane linkage with isocyanate to produce a polyurethane dispersion (PUD). A polyurethane dispersion may be formed according to embodiments of the present invention by the inclusion of a diol component with a tertiary carboxylic group during the formation of the hydrolytically stable polymer dispersion. For example, dimethylol propionic acid, diethylol propionic acid or dimethyol butanoic acid may be included during the formation of the hydrolytically stable polymer dispersion in order to provide a carboxylic group in the polymers capable of forming a salt with an amine. The use of tertiary carboxylic groups prevents unwanted reactions between the carboxylic groups and isocyanate, thereby allowing the formation of a water dispersible polyurethane dispersion.

According to other embodiments of the present invention, the hydrolytically stable polymer dispersions of the present invention may be prepared by emulsifying the hydrolytically stable polymer. The emulsification of the hydrolytically stable polymer may be performed by adding an emulsifier and water to the hydrolytically stable polymer to form a mixture, followed by subjecting the mixture to shear forces. For example, a hydrolytically stable polymer according to embodiments of the present invention may be mixed with an emulsifier such as a cationic, anionic, or non-ionic surfactant and passed through a homonizer to subject the mixture to shear forces. The resulting emulsification may lead to hydrolytically stable polymer dispersion.

In other embodiments of the present invention a hydrolytically stable polymer may be dispersed in water by chemically incorporating hydrophilic moieties into the polymer chains of the hydrolytically stable polymer. Hydrophilic moieties may be incorporated into the polymer chains of the hydrolytically stable polymer through condensation reaction with other hydroxy or carboxy compounds. Examples of hydrophilic moieties that may be incorporated into the polymer chains include, but are not limited to, poly(ethylene glycol), methoxy terminated poly (ethylene glycol), poly (propylene glycol), methoxy-terminated poly (propylene glycol), and metal salts of sulfo-isophthalic acid. The incorporation of hydrophilic moieties into the polymer chains of the hydrolytically stable polymer results in dispersions that may be dispersed in water without the need for salt formation or for the use of surfactants.

The extent of hydrolysis of a hydrolytically stable polymer dispersion of the present invention may be determined by measuring the acid value. For example, a comparison of the beginning acid value and the current acid value of a dispersion may be used to measure the amount of hydrolysis that has occurred in the dispersion. The hydrolysis of an ester linkage generates a carboxylic group, which in turn raises the acid value of a dispersion. Thus, an increased acid value of a dispersion indicates that hydrolysis has occurred.

According to other embodiments of the present invention, the hydrolytically stable polymer dispersions may be heat aged to improve the viscosity of the dispersion. Heat aging includes the exposure of a hydrolytically stable polymer dispersion to a heat source for a period of time following, or during, manufacturing. For instance, a hydrolytically stable polymer dispersion may be exposed to a thermal source imparting a temperature in the hydrolytically stable polymer dispersion at or between about 65° C. to about 98° C. or higher over a period of between about 2 to about 72 hours or longer. It is believed that the exposure of the hydrolytically stable polymer dispersion to the heat source shortens the time required for the polymer chains in the hydrolytically stable polymer dispersion to rearrange into a thermodynamically stable compressed form that is not subject to viscosity changes. As a result, the heat aged hydrolytically stable polymer dispersion exhibits improved viscosity characteristics.

In other embodiments of the present invention, the viscosity characteristics of a hydrolytically stable polymer dispersion may be altered by reacting trimellitic anhydride with a hydroxy group of a polymer in the hydrolytically stable polymer dispersion. The reaction of trimellitic anhydride with the hydroxy group generates two neighboring aromatic acids, which lowers the dispersion viscosity of the hydrolytically stable polymer dispersion.

The hydrolytically stable polymer dispersions of the present invention may be used to form paints, inks, adhesives, and other coatings products as well as to form cosmetic formulations, hair products, soaps, gels, shampoos, conditioners, cleansers, and lubricants.

The following Examples illustrate methods for forming hydrolytically stable polymer dispersions according to embodiments of the present invention. Although the Examples provide details for forming hydrolytically stable polymer dispersions and for carrying out various embodiments of the present invention, the Examples are not meant to be limiting in any way.

### EXAMPLE 1

### Prior Art

A conventional polyester dispersion was prepared as a comparative example for the hydrolytically stable polymer dispersions of the present invention. The polyester dispersion was prepared by salt formation and was formed only with primary hydroxy compounds.

To a 3 liter flask reactor equipped with a pack column, nitrogen blanketing, and a water receiver was charged 150 grams of trimethylol propane, 400 grams of neopentyl glycol, 300 grams of isophthalic acid, 300 grams of adipic acid, and 0.5 grams of dibutyltin oxide. The temperature of the reactor was raised to 210° C. and maintained while collecting forming water until the Acid Value (AV) divided by the non-volatile value (NV) was 4.8 and the reduced viscosity at 75 NV in xylene was 9.0 stokes. The reactor was cooled to 160° C. and 81 grams of trimelltic anhydride was charged to the reactor. The reactor was maintained at 160° C. for one hour until AV/NV was 40.4 and the reduced viscosity at 70 NV in xylene was 15.6 stokes. The reactor was then cooled. 80 grams of N,N-dimethyl ethanol amine was added to the reactor when the temperature dropped below 120° C. and cooling continued. When the temperature dropped below 100° C., 900 grams of deionized water was added to the reactor with agitation. The resulting polyester dispersion had an NV of 49.8, a pH of 8.34, a viscosity of 176 poise, and an AV of 21.0.

### EXAMPLE 2

A hydrolytically stable polymer dispersion was formed according to embodiments of the present invention by salt formation in which the ester linkages were formed from 25 percent by mole of secondary hydroxy groups. The reaction proceeded as follows:

To a 3 liter flask reactor equipped with a pack column, nitrogen blanketing, and a water receiver was charged 205 grams of trimethylol propane, 338 grams of trimethyl pentanediol, 228 grams of isophthalic acid, 228 grams of adipic acid, and 0.5 grams of dibutyl tin dioxide. The temperature of the reactor was raised to 210° C. and maintained while collecting forming water until AV/NV was 6.1 and the reduced viscosity at 70 NV in xylene was 8.5 stokes. The reactor was cooled to 160° C. and then 60 grams of trimelltic anhydride was charged. The reactor was maintained at 160° C. for about 50 minutes until AV/NV was 38.8 and the reduced viscosity at 70 NV in xylene was 15.6 stokes. The reactor was then cooled. Once the reactor temperature dropped below 120° C., 60 grams of N,N-dimethyl ethanol amine was added to the reactor. Cooling continued. 800 grams of deionized water was charged to the reactor with agitation when the temperature dropped below 100° C. The resulting hydrolytically stable polymer dispersion had an NV of 48.5, a pH of 7.44, a viscosity of 320 poise, and an AV of 19.7.

### EXAMPLE 3

A hydrolytically stable polymer dispersion was formed according to embodiments of the present invention by salt formation in which the ester linkages were formed from 55 percent by mole of secondary hydroxy groups. The reaction proceeded as follows:

To a 3 liter flask reactor equipped with a pack column, nitrogen blanketing, and a water receiver was charged 31 grams of trimethylol propane, 437 grams of trimethyl pentanediol, 156 grams of hydrogenated bisphenol A, 187 grams of isophthalic acid, 187 grams of adipic acid, and 0.5 grams of dibutyltin oxide. The temperature of the reactor was raised to 210° C. and maintained while collecting forming water until AV/NV was 4.6 and the reduced viscosity at 70 NV in xylene was 1.5 stokes. 400 grams of the formed polymer was transferred to a second reactor and 31 grams of trimelltic anhydride was charged to the second reactor. The second reactor was maintained at 160° C. for about 50 minutes until AV/NV was 42.7 and the reduced viscosity at 70 NV in xylene was 7.8 stokes. The second reactor was then cooled. When the temperature of the second reactor dropped below 120° C., 37 grams of N,N-dimethyl ethanol amine was added to the second reactor. 400 grams of deionized water was charged with agitation to the second reactor when the temperature dropped below 100° C. The resulting hydrolytically stable polymer dispersion had an NV of 46.8, a pH of 8.72, a viscosity of 0.4 poise, and an AV of 22.0.

### EXAMPLE 4

A hydrolytically stable polymer dispersion was formed according to embodiments of the present invention by salt formation in which the ester linkages were formed from 77 percent by mole of secondary hydroxy groups. The reaction proceeded as follows:

To a 3 liter flask reactor equipped with a pack column, nitrogen blanketing, and a water receiver was charged 235 grams of trimethyl pentanediol, 411 grams of hydrogenated bisphenol A, 176 grams of isophthalic acid, 176 grams of of adipic acid, and 0.5 grams of dibutyltin oxide. The temperature of the reactor was raised to 210° C. and maintained while collecting forming water until AV/NV was 7.3 and the reduced viscosity at 70 NV in xylene was 12.9 stokes. The reactor was cooled to 160° C. and then 67 grams of trimellitic anhydride was charged. The reactor was maintained at 160° C. for about 45 minutes until AV/NV was 47.4. The reactor was then cooled. Once the reactor temperature dropped below 120° C., 93 grams of N,N-dimethyl ethanolamine and 100 grams of t-butoxy propanol were added to the reactor. Cooling continued. 800 grams of deionized water was charged to the reactor with agitation when the temperature dropped below 100° C. The resulting hydrolytically stable polymer dispersion had an NV of 45.7, a pH of 9.03, a viscosity of 2.0 poise, and an AV of 22.9.

### EXAMPLE 5

A hydrolytically stable polymer dispersion was formed according to embodiments of the present invention by salt formation in which the ester linkages were formed from 69 percent by mole of secondary hydroxy groups. The reaction proceeded as follows:

To a 3 liter flask reactor equipped with a pack column, nitrogen blanketing, and a water receiver was charged 34 grams of trimethylol propane, 236 grams of trimethyl pentanediol, 381 grams of hydrogenated bisphenol A, 182 grams of isophthalic acid, 168 grams of adipic acid, and 0.5 grams of dibutyltin oxide. The temperature of the reactor was raised to 210° C. and maintained while collecting forming water until AV/NV was 8.7 and the reduced viscosity at 70 NV in xylene was 8.8 stokes. The reactor was cooled to 160° C. and then 84 grams of trimellitic anhydride was charged. The reactor was maintained at 160° C. for about 40 minutes until AV/NV was 54.0. The reactor was then cooled. Once the reactor temperature dropped below 120° C., 90 grams of N,N-dimethyl ethanol amine was added to the reactor and cooling continued. 800 grams of deionized water was charged to the reactor with agitation when the temperature dropped below 100° C. The resulting hydrolytically stable polymer dispersion had an NV of 48.3, a pH of 8.74, a viscosity of 2.0 poise, and an AV of 26.4.

### EXAMPLE 6

A hydrolytically stable polymer dispersion was formed according to embodiments of the present invention by salt formation in which the ester linkages were formed from 91 percent by mole of secondary hydroxy groups. The reaction proceeded as follows:

To a 3 liter flask reactor equipped with a pack column, nitrogen blanketing, and a water receiver was charged 21 grams of trimethylol propane, 497 grams of hydrogenated bisphenol A, 359 grams of sunflower fatty acid, 120 grams of isophthalic acid, 60 grams of adipic acid and 0.5 grams of dibutyltin oxide. The temperature of the reactor was raised to 220° C. and maintained while collecting forming water until AV/NV was 5.5 and the reduced viscosity at 70 NV in xylene was 1.5 stokes. 400 grams of product was removed from the reactor to be used with other Examples of the present invention. The reactor was cooled to 160° C. and then 50 grams of trimellitic anhydride was charged. The reactor was maintained at 160° C. for about 50 minutes until AV/NV was 46.9. The reactor was then cooled. 15 grams of n-butoxy ethanol was added into the reactor. When the temperature of the reactor dropped below 100° C., a mixture of 36 grams of ammonium hydroxide (approximately 30% in water) and 400 grams of deionized water was added to the reactor with agitation. The resulting hydrolytically stable polymer dispersion had an NV of 54.9, a pH of 8.94, a viscosity of 163 poise, and an AV of 26.4.

### EXAMPLE 7

A hydrolytically stable polymer dispersion was formed according to embodiments of the present invention by applying shear force in the presence of a surfactant in which the ester linkages were formed from 91 percent by mole of secondary hydroxy groups. The reaction proceeded as follows:

100 grams of the product produced before trimellitic anhydride addition in Example 6 was mixed with 14.5 grams of IGEPAL CO-630 and 100 grams of water and hand mixed. The mixture was passed through IKA homonizer at 60 Hz frequency. The resulting hydrolytically stable polymer dispersion had an NV of 42.1, a pH of 3.11, and a viscosity of 0.6 poise.

### EXAMPLE 8

A hydrolytically stable polymer dispersion was formed according to embodiments of the present invention by chemically incorporating hydrophilic moiety into a hydrolytically stable polymer dispersion wherein the ester linkages were formed from 93 percent by mole of secondary hydroxy groups. The reaction proceeded as follows:

To a 3 liter flask reactor equipped with a pack column, nitrogen blanketing, and a water receiver was charged 311 grams of Carbowax 4600 (polyethylene glycol) and 40 grams of glycidyl neodecanoate and 0.3 grams of dibutyltin oxide. The temperature of the reactor was raised to 210° C. When an exotherm leading to 240° C. was observed, the reactor was cooled to ambient temperature. 44 grams of trimethyl pentanediol, 400 grams of hydrogenated bisphenol A, 44 grams of isophthalic acid and 211 grams of adipic acid were then charged to the reactor. The temperature was raised to between 210° C. and 220° C. and maintained while collecting forming water until AV/NV was 11.9. The reactor was then cooled. When the temperature reached 160° C., 350 grams of n-butoxy ethanol was charged to the reactor and cooling continued. When the temperature dropped below 100° C., 1500 grams of de-ionized water was added to the reactor with agitation. The resulting hydrolytically stable polymer dispersion had an NV of 18.9, a pH of 3.30, a viscosity of 40 poise, and an AV of 2.27.

### EXAMPLE 9

A hydrolytically stable polymer dispersion was formed according to embodiments of the present invention wherein the ester linkages were formed from 81 percent by mole of secondary hydroxy groups. The reaction proceeded as follows:

To a 3 liter flask reactor equipped with a pack column, nitrogen blanketing, and a water receiver was charged 200 grams of trimethylpentanediol, 453 grams of hydrogenated Bisphenol A, 150 grams of isophthalic acid, 150 grams of adipic acid and 0.5 grams of dibutyltin oxide. The temperature was raised to 220° C. and maintained while collecting forming water until AV/NV was 1.6 and the reduced viscosity at 70 NV in xylene was 10.7 stokes. The resulting hydrolytically stable polymer dispersion had a hydroxy value (OHV) of 112.

### EXAMPLE 10

### Prior Art

A conventional polyester dispersion was prepared as a comparative example for the hydrolytically stable polymer dispersions of the present invention. The polyurethane dispersion was prepared by salt formation and was formed without secondary hydroxy compounds.

To a 1 liter clean, dry flask reactor equipped with an agitator, thermometer, nitrogen inlet and outlet were charged 250 grams of Ruco S1019-120 polyester polyol (1000 MW, based on 1,6 hexanediol, adipic acid and isophthalic acid), 29 grams of DMPA (dimethylolpropionic acid), 180 grams of NMP (N-methylpyrrolidinone) and 160.1 grams of Desmodur W (methylene bis (4-cyclohexyl isocyanate). The temperature of the reactor was raised to 95° C. under a dry nitrogen atmosphere and maintained at 95° C. until the prepolymer NCO content reached the theoretical value of 1.96 percent. The reactor was then cooled to 65° C., and 30 grams of NMP and 21.86 grams of TEA (triethylamine) were charged to the prepolymer in the reactor. The prepolymer solution was mixed for 15 minutes and 550 grams of the neutralized prepolymer was dispersed into 435 grams of deionized water. The dispersed prepolymer was then chain extended by adding a solution of 17.13 grams of 15.5 percent by weight in water of hydrazine and 34 grams of deionized water. The resulting polyurethane dispersion had an NV of 34.9, a pH of 7.42, a viscosity of 59 centipoise, and an AV of 9.38.

### EXAMPLE 11

A hydrolytically stable polymer dispersion was formed according to embodiments of the present invention by salt formation in which the ester linkages were formed from 70 percent by mole of secondary hydroxy groups. The reaction proceeded as follows:

To a 1 liter clean, dry flask reactor equipped with an agitator, thermometer, nitrogen inlet and outlet were charged 200 grams of polyester polyol (1000 MW) from Example 9, 50 grams of Ruco S1019-120 polyester polyol, 29 grams of DMPA, and 180 grams of NMP. The ingredients were stirred and heated slowly to 95° C. under a dry nitrogen atmosphere and then cooled to below 40° C. 160.1 grams of Desmodur W was charged to the reactor after cooling and the temperature was raised to 95° C. The reactor was maintained at 95° C. until the prepolymer NCO content reached the theoretical value of 1.96. The reactor was then cooled to 65° C., and 30 grams of NMP and 21.86 grams of TEA were charged into the prepolymer in the reactor. The prepolymer mixture was mixed for 15 minutes then 550 grams of the neutralized prepolymer was dispersed into 435 grams of deionized water. The dispersed prepolymer was then chain extended by adding a solution consisting of 17.13 grams of 15.5 percent by weight in water of hydrazine and 34 grams of deionized water. The resulting polyurethane dispersion had an NV of 34.3, a pH of 7.41, a viscosity of 92 centipoise, and an AV of 9.74.

### EXAMPLE 12

A white paint was prepared with a hydrolytically stable polymer dispersion formed according to the embodiments of the present invention. To a ball mill were charged 419 grams of the hydrolytically stable polymer dispersion of Example 5, 273 grams of Tipure R-902 pigment (manufactured by DuPont), 12 grams of deionized water and approximately 250 grams of glass beads. After grinding for one hour on a paint shaker to obtain a 7+Hegman Grind, 210 grams of the hydrolytically stable polymer dispersion of Example 5 and 76 grams of Cymel 303 (20 percent by weight on resin solids) were added. The paint mixture was mixed well to ensure that Stormer viscosity was within 60-70 KU (Kreb Unit). The paint mixture was then filtered through a 10 micron bag and baked at 176.7° C. for 30 minutes. The resulting white paint showed a gloss of 92/74 and pencil hardness of 4H.

### EXAMPLE 13

A white paint was prepared with a hydrolytically stable polymer dispersion formed according to the embodiments of the present invention. To a ball mill were charged 369 grams of the hydrolytically stable polymer dispersion of Example 6, 274 grams of Tipure R-902 pigment (manufactured by DuPont), 113 grams of deionized water and approximately 250 grams of glass beads. After grinding for one hour on a paint shaker to obtain a 7+Hegman Grind, 184 grams of hydrolytically stable polymer dispersion of Example 6 and a mixture of 3.1 grams of Cobalt Hydrocure II Drier (OMG) and 0.8 grams of Activ 8 (RT Vanderbilt) were added to the mixture. The paint mixture was filtered through a 10 micron bag. The resulting white paint has a gloss of 94/85.

Samples of the hydrolytically stable polymer dispersions formed in the Examples were tested to determine the hydrolytic stability of the samples as compared to samples of the comparative polymer dispersions of Examples 1 and 10. The acid values (AV) were used to monitor the progress of hydrolysis in the samples since the hydrolysis of each ester linkage in a polyester and alkyd polymer generates one carboxylic group. The test data are shown in Table I. The numbers in the parenthesis represent the increase in acid value after heat aging the sample at 48.9° C. and the numbers marked by asterisks (*) represent acid values at 60° C.

TABLE I

| | Initial | 1 week | 2 weeks | |
|---|---|---|---|---|
| | Acid value | Acid value | Acid value | |
| Dispersion | (solids) | (solids) | (solids) | 3 weeks |
| Example 1 - polyester | 42.2 | 46.4 | 50.0 | 52.6 |
| (0% secondary ester | | (+4.2) | (+7.8) | (+10.4) |
| linkage) | | | | |
| Example 2 - polyester | 40.6 | 43.7 | 48.0 | 50.5 |
| (25% secondary ester | | (+3.1) | (+7.4) | (+9.9) |
| linkage) | | | | |
| Example 3 - polyester | 45.1 | 46.6 | 48.5 | 51.3 |
| (55% secondary ester | | (+1.5) | (+3.4) | (+6.2) |
| linkage) | | | | |
| Example 5 - polyester | 45.1 | 45.8 | 46.8 | |
| (77% secondary ester | | (+0.8) | (+1.7) | |
| linkage) | | | | |
| Example 6 - alkyd | 48.1 | 48.6 | 52.1 | |
| (91% secondary ester | | (+0.5) | (+4.0) | |
| linkage) | | | | |
| Example 10 - | 26.9 | 27.1 | 27.5 | 28.9 |
| polyurethane | | | | |
| (0% secondary ester | | (+0.2) | (+0.6) | (+2.0) |
| linkage) | | | | |
| Example 10 - | 26.9 | 29.0* | 29.7* | 31.7* |
| polyurethane | | | | |
| (0% secondary ester | | (+2.1) | (+2.8) | (+4.8) |
| linkage) | | | | |
| Example 11 - | 28.4 | 28.6 | 28.6 | 28.7 |
| polyurethane | | | | |
| (70% secondary ester | | (+0.2) | (+0.2) | (+0.3) |
| linkage) | | | | |
| Example 11 - | 28.4 | 28.6* | 28.7* | 28.8* |
| polyurethane | | | | |
| (70% secondary ester | | (+0.2) | (+0.3) | (+0.4) |
| linkage) | | | | |

The data indicate that acid values of the hydrolytically stable polymer dispersions formed according to embodiments of the present invention undergo a smaller increase, which indicates improved hydrolytic stability. In addition, the hydrolytic stability of the hydrolytically stable polymer dispersions of the present invention increases as the amount of ester linkages formed by secondary hydroxy group increases. Thus, by increasing the number or percentage of polymer ester linkages in the polymer backbone formed by secondary and/or tertiary hydroxy groups, the hydrolytic stability of a polymer dispersion may be improved. The embodiments of the present invention provide polymer dispersions having increased amounts of polymer backbone ester linkages formed from secondary and/or tertiary hydroxy groups and methods of making such polymer dispersions. The improved hydrolytic stability may result in longer shelf lives for paints, inks, adhesives, or other coatings utilizing the hydrolytically stable polymer dispersions of the present invention.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A polyester and alkyd polymer dispersion comprising polymers having backbone ester linkages, wherein at least a portion of the backbone ester linkages are formed from secondary and/or tertiary hydroxy groups.

2. The polyester and alkyd polymer dispersion of claim 1, wherein at least 5 mole percent of the backbone ester linkages are formed from secondary and/or tertiary hydroxy groups.

3. The polyester and alkyd polymer dispersion of claim 1, wherein at least 25 mole percent of the backbone ester linkages are formed from secondary hydroxy groups.

4. The polyester and alkyd polymer dispersion of claim 3, wherein the secondary hydroxy groups originate from polyols selected from the group consisting of 2,2,4-trimethyl pentanediol, 2,2′-bis (4-hydroxycyclohexy) propane (hydrogenated bisphenol A), propylene glycol, di-propylene glycol, poly (propylene glycol), glycerol, and sorbitol.

5. The polyester and alkyd polymer dispersion of claim 1, further comprising backbone ester linkages formed from primary hydroxy groups.

6. The polyester and alkyd polymer dispersion of claim 5, wherein the primary hydroxy groups originate from polyols selected from the group consisting of trimethylol propane, pentaerythritol, di-pentaerythritol, trimethylol ethane, neopentyl glycol, ethylene glycol, 1,3-butanediol, 1,4-butanediol, 1,6-hexanediol, 1,4-cyclohexyl dimethanol, diethylene glycol, triethylene glycol, poly (ethylene glycol), poly (tetrahydrofuran), poly(caprolactone) diol, poly(caprolactone) triol, trimethylol mono allylether, trimethylol diallyl ether, pentaerythritol triallylether, pentaerythritol diallyl ether, pentaerythritol mono allylether, 2-ethyl-2-(hydroxymethyl)-1,3-propanediol, and 2-methyl 1,3-propanediol.

7. A hydrolytically stable polymer dispersion comprising polymers having polymer backbone ester linkages, wherein at least 5 mole percent of the polymer backbone ester linkages are formed from secondary hydroxy groups.

8. The hydrolytically stable polymer dispersion of claim 7, wherein the polymer backbone ester linkages are formed from alkyl substituted epoxy compounds and alkyl substituted cyclic carbonates.

9. The hydrolytically stable polymer dispersion of claim 8, wherein the epoxy compounds and alkyl substituted cyclic carbonates are selected from the group consisting of glycidyl neodecanoate, diglycidyl ether of bisphenol A, diglycidyl ether of bisphenol F, pentaerythritol poly glycidyl ether, sorbitol polyglycydyl ether, propylene oxide, and propylene carbonate.

10. The hydrolytically stable polymer dispersion of claim 7, further comprising ester linkages formed from primary hydroxy groups.

11. The hydrolytically stable polymer dispersion of claim 10, wherein the primary hydroxy groups originate from polyols selected from the group consisting of trimethylol propane, pentaerythritol, di-pentaerythritol, trimethylol ethane, neopentyl glycol, ethylene glycol, 1,3-butanediol, 1,4-butanediol, 1,6-hexanediol, 1,4-cyclohexyl dimethanol, diethylene glycol, triethylene glycol, poly (ethylene glycol), poly (tetrahydrofuran), poly(caprolactone) diol, poly(caprolactone) triol, trimethylol mono allylether, trimethylol diallyl ether, pentaerythritol triallylether, pentaerythritol diallyl ether, pentaerythritol mono allylether, 2-ethyl-2-(hydroxymethyl)-1,3-propanediol, and 2-methyl 1,3-propanediol.

12. A method for forming a hydrolytically stable polymer dispersion, comprising:
forming polymers having backbone ester linkages from reactants selected from the group consisting of secondary hydroxy-containing polyols, primary hydroxy-containing polyols, polyacids, oils, fatty acids, mono-functional acids, and mono-functional alcohols; and dispersing said polymers.

13. The method of claim 12, wherein the secondary hydroxy-containing polyols are selected from the group consisting of 2,2,4-trimethyl pentanediol, 2,2′-bis (4-hydroxycyclohexy) propane(hydrogenated bisphenol A), propylene glycol, di-propylene glycol, poly (propylene glycol), glycerol, and sorbitol.

14. The method of claim 12, wherein the primary hydroxy-containing polyols are selected from the group consisting of trimethylol propane, pentaerythritol, di-pentaerythritol, trimethylol ethane, neopentyl glycol, ethylene glycol, 1,3-butanediol, 1,4-butanediol, 1,6-hexanediol, 1,4-cyclohexyl dimethanol, diethylene glycol, triethylene glycol, poly (ethylene glycol), poly (tetrahydrofuran), poly(caprolactone) diol, poly(caprolactone) triol, trimethylol mono allylether, trimethylol diallyl ether, pentaerythritol triallylether, pentaerythritol diallyl ether, pentaerythritol mono allylether, 2-ethyl-2-(hydroxymethyl)-1,3-propanediol, and 2-methyl 1,3-propanediol.

15. The method of claim 12, wherein the polyacids are selected from the group consisting of isophthalic acid, terephthalic acid, 5-(sodiosulfo)-isophthalic acid, trimellitic anhydride, adipic acid, 1,4-cyclohexyl dicarboxylic acid, succinic anhydride, maleic acid, fumaric acid, succinic acid, azaleic acid, sebacic acid, methyl succinic anhydride, dodecenyl succinic anhydride, tetrahydrophthalic anhydride, hexahydrophthalic anhydride, and phthalic anhydride.

16. The method of claim 12, wherein the oils are selected from the group consisting of sunflower oil, toll oil, soybean oil, safflower oil, linseed oil, castor oil, dehydrated castor oil and tung oil.

17. The method of claim 12, wherein the fatty acids are selected from the group consisting of sunflower fatty acid, toll oil fatty acid, linseed oil fatty acid, safflower oil fatty acid, dehydrated castor oil fatty acid and soybean oil fatty acid.

18. The method of claim 12, wherein the mono-functional acids are selected from the group consisting of benzoic acid and aliphatic hydrocarbon acids.

19. The method of claim 12, wherein the mono-functional alcohols are selected from the group consisting of alkoxy terminated poly(ethylene glycol) and alkoxy terminated poly(propylene) glycol.

20. The method of claim 12, further comprising forming the hydrolytically stable polymer dispersion by salt formation between an amine and a carboxylic group chemically bound to at least a portion of the polymers of the hydrolytically stable polymer dispersion.

21. The method of claim 20, further comprising reacting di-hydroxy compounds with tertiary carboxylic groups.

22. The method of claim 20, further comprising reacting at least one amine with the polymers of the hydrolytically stable polymer dispersion.

23. The method of claim 22, wherein the at least one amine is selected from the group consisting of aqueous ammonia, triethyl amine, N,N-dimethyl ethanol amine and N-methyl morpholine.

24. The method of claim 12, further comprising reacting the polymers of the hydrolytically stable polymer dispersion with an anhydride.

25. The method of claim 24, wherein the anhydride is selected from the group consisting of trimellitic anhydride, maleic anhydride, phthalic anhydride, dodecenyl succinic anhydride, pyromellitic dianhydride, cyclohexane dicarboxylic anhydride, (2,5-dioxotetrahydrol)-3-methyl 3-cyclohexene-1,2 dicarboxylic anhydride and succinic anhydride.

26. The method of claim 12, further comprising: mixing the hydrolytically stable polymer dispersion with an emulsifier and water; and subjecting the mixture to shear forces.

27. The method of claim 26, wherein said emulsifier is selected from the group consisting of cationic surfactants, anionic surfactants, and non-ionic surfactants.

28. The method of claim 12, further comprising incorporating hydrophilic moieties into the polymers of the hydrolytically stable polymer dispersion.

29. The method of claim 28, wherein incorporating hydrophilic moieties into the polymers of the hydrolytically stable polymer dispersion comprises incorporating hydrophilic moieties by condensation reaction.

30. The method of claim 28, wherein the hydrophilic moieties are selected from the group consisting of poly(ethylene glycol), methoxy terminated poly (ethylene glycol), poly (propylene glycol), methoxy-terminated poly (propylene glycol) and metal salts of sulfo-isophthalic acid.

31. The method of claim 12, wherein at least 5 mole percent of the polymer backbone ester linkages are formed from secondary and/or tertiary hydroxy groups.

32. The method of claim 12, wherein at least 10 mole percent of the polymer backbone ester linkages are formed from secondary and/or tertiary hydroxy groups.

33. The method of claim 12, wherein at lest 15 mole percent of the polymer backbone ester linkages are formed from secondary and/or tertiary hydroxy groups.

34. The method of claim 12, wherein at least 20 mole percent of the polymer backbone ester linkages are formed from secondary and/or tertiary hydroxy groups.

35. The method of claim 12, wherein at least 25 mole percent of the polymer backbone ester linkages are formed from secondary and/or tertiary hydroxy groups.

36. A paint composition comprising a pigment and at least one polyester and alkyd polymer dispersion, wherein at least 5 mole percent of the polymer ester linkages of the polyester and alkyd polymers are formed from secondary and/or tertiary hydroxy groups.

37. An ink composition comprising a pigment and at least one polyester and alkyd polymer dispersion, wherein at least 5 mole percent of the polymer ester linkages of the polyester and alkyd polymers are formed from secondary and/or tertiary hydroxy groups.

38. An adhesive composition comprising polyester and alkyd polymers, wherein at least 5 mole percent of the ester linkages of the polyester and alkyd polymers are formed from secondary and/or tertiary hydroxy groups.
